(19) United States
(12) Patent Application Publication
(10) Pub. No.: US 2024/0210443 A1
(43) Pub. Date: Jun. 27, 2024

(54) FIDUCIAL MARKER DESIGN, FIDUCIAL MARKER, SCANNING PROBE MICROSCOPY DEVICE AND METHOD OF CALIBRATING A POSITION OF A PROBE TIP

(71) Applicant: Nearfield Instruments B.V., Rotterdam (NL)

(72) Inventors: Hamed SADEGHIAN MARNANI, Rotterdam (NL); Arseniy KALININ, Rotterdam (NL)

(21) Appl. No.: 18/288,649

(22) PCT Filed: Apr. 28, 2022
(86) PCT No.: PCT/NL2022/050229

§ 371 Date: Oct. 27, 2023

(30) Foreign Application Priority Data
Apr. 28, 2021 (NL) 2028082

(51) Int. Cl. G01Q 40/02; G01Q 10/06; G01Q 20/04

(52) U.S. Cl. CPC G01Q 40/02; G01Q 10/065; G01Q 20/04

(57) ABSTRACT

The invention is directed at a fiducial marker design, a fiducial marker, a scanning probe microscopy device and a method of calibrating a position of a probe tip. The fiducial marker design may be used as a fiducial marker for providing a positioning reference, and comprises at least one first reference pattern including at least one first reference element for enabling determination of a relative position of the fiducial marker with respect to a first sensor. The first sensor is configured for operating at a first scale of dimension. The fiducial marker further comprises a second reference pattern, which comprises a regular arrangement of markings, structured or shaped such as to encode therein surface coordinate information. This enables determination of a relative position of each marking with respect to a second sensor configured for operating at a second scale of dimension smaller than the first scale of dimension.

### FIELD OF THE INVENTION

The present invention is directed at a fiducial marker design for use as a fiducial marker for providing a positioning reference. The invention is further directed at a fiducial marker in accordance with the above design, and at a scanning probe microscopy system including such a fiducial marker.

### BACKGROUND

Scanning probe microscopes (SPM), such as atomic force microscopes (AFM), operate by scanning a probe tip relative to a substrate surface, while intermittently or continuously establishing contact between the probe tip and the surface. Although this enables the highly accurate visualization of nanometer sized features on the surface of the substrate, frequent or continuous contact between the probe tip and the surface causes to the probe tip to wear. Frequent replacements of the probe tip are therefore necessary in order to ensure the desired accuracy of the atomic force microscope.

Although exchanging the probe tip may be performed very accurately, each tip exchange typically results in an uncertainty of approximately 10 μm to 50 μm in the exact location of the tip. To be able to accurately locate the point of interest on a substrate to be scanned with the probe tip in use, the location of the probe tip must be known with much greater accuracy.

To calibrate the system such as to determine the exact location of the probe tip, one possibility is to scan a reference surface with known surface features. Substrates, such as wafers, include fiducial markers to establish their position and orientation. These fiducial markers may also enable probe tip calibration. By scanning a part of the fiducial marker and visualizing the scanned area, a controller may resolve the part of the fiducial visualized and thereby relate the probe tip location to that of the fiducial marker. However, for industrial applications, the probe tip calibration needs to be performed both accurately as well as quickly in order to not to lose too much valuable time on tip exchanging. The above calibration procedure requires to measure a full 2D image, and to analyze the image obtained and hence costs valuable time to perform.

### SUMMARY OF THE INVENTION

It is an object of the present invention to provide a fiducial marker design that enables the calibration method to be performed both accurately as well as quickly.

To this end, there is provided herewith a Fiducial marker design for use as a fiducial marker for providing a positioning reference, the fiducial marker comprising at least one first reference pattern including at least one first reference element for enabling determination of a relative position of the fiducial marker with respect to a first sensor, the first sensor being configured for operating at a first scale of dimension, wherein the fiducial marker further comprises a second reference pattern, wherein the second reference pattern comprises a regular arrangement of markings, the markings being structured or shaped such as to encode therein surface coordinate information, for enabling determination of a relative position of each marking with respect to a second sensor, the second sensor being configured for operating at a second scale of dimension, the second scale of dimension being smaller than the first scale of dimension.

The fiducial marker design of the present invention provides a two-fold functionality with respect to probe tip position determination within the system. Using the first reference pattern, the exact location of the fiducial in the system can be established by means of an optical microscope or sensor applied as the first sensor above. For example, suppose the fiducial is located on a reference surface fixed to the metrology frame of the system, the exact location of the fiducial in the SPM system is known. This is because this position does not change in use, and can therefore be exactly determined by the manufacturer of the SPM system. This data may be made available upon installation of the system and is associated exclusively with that system. Using the first sensor, i.e. the optical sensor of the example, at least one first reference element enables determination of the relative location of the fiducial marker with respect to the first sensor. The first sensor is also related to the probe head and its position is thus fixed (but unknown) relative to the newly installed probe tip. A major advantage is obtained by the second reference pattern. This second reference pattern comprises a regular arrangement of markings that are structured or shaped such as to encode therein surface coordinate information. The resolution of the coordinate information is only limited by the accuracy with which the markings can be fabricated. This can be done without difficulty at the same scale of dimension as the surface features that need to be scanned on the surface of a substrate. Thus, a regular arrangement of markings encoding coordinate information of a coordinate system at nanometer scale may be provided in this manner, and thus enables to provide a reference coordinate system within the fiducial marker at any desired resolution. By scanning the probe tip across these markings, the exact location of the probe tip within the fiducial can be established. Because the location of the fiducial is exactly known, the location of the probe tip with respect to the system and with respect to the first sensor is also known.

Optionally, the exact location of the probe head may further be established via a coordinate reference grid plate which is also used for positioning of the scan head relative to the substrate surface. In this way, regardless of the exact location of the fiducial within the SPM system, the probe tip location can be accurately calibrated, via the information obtained from the first sensor, relative to the coordinate reference grid plate. The fiducial in that case no longer requires to be at a known and fixed location within the system, but could be on a moveable part thereof—such as the substrate carrier or even the substrate surface.

In some embodiments, the second reference pattern includes a first regular arrangement of markings and a second regular arrangement of markings, wherein the first regular arrangement of markings is structured or shaped such as to encode therein surface coordinate information of a first surface coordinate associated with a first direction parallel to the surface of the fiducial marker, and wherein the second regular arrangement of markings is structured or shaped such as to encode therein surface coordinate information of a second surface coordinate associated with a second direction parallel to the surface of the fiducial marker. In these embodiments, surface coordinates in two directions may be encoded enabling to provide a cartesian coordinate system, polar coordinate system, or any other desired coordinate system. For example, it is possible to provide markings having variable dimensions in two directions, wherein the coordinate information is encoded in the variation of these dimensions. A regular pattern of rectangles, wherein the width gradually increases in one orthogonal direction and wherein the height gradually increases in the other orthogonal direction, enables to encode an X and a Y coordinate of a cartesian coordinate system. Similarly, instead of rectangles, different shapes may be applied. For example, a grid having horizontal and vertical lines, the lines gradually increasing in thickness in a similar manner as the rectangles above, may also be applied. Furthermore, other line patterns are possible, consisting of horizontal and vertical lines or unique arrangements of dots may likewise encode this information in a similar way.

In some embodiments, the first direction is transverse to the second direction for providing a cartesian coordinate system, as mentioned above. In other or further embodiments, the first direction is a radial direction extending outward from a center point, and the second direction is an angular direction extending circularly around the center point, such as to provide a polar coordinate system.

In some embodiments, for at least one of the first or second regular arrangement of markings, each of the markings is provided by a bar having a predetermined thickness for encoding therein a sequence of binary values, wherein the bars extend in an extension direction and are arranged side by side in an arrangement direction. The extension direction and arrangement direction may be different directions. Examples of this have already been discussed above, such as the examples describing the horizontal and vertical lines of different thicknesses. Such lines extend in the first direction, and form a regular arrangement over the second direction. In these embodiments, however, the extension direction and arrangement direction do not need to correspond to the first and second direction referred to above. It is also possible that the markings are regularly arranged in e.g. the first direction above, while the markings extend obliquely to the first direction.

For example, suppose the extension direction makes an angle of π/4 radians with the arrangement direction, while the arrangement direction corresponds to the first direction. This way, coordinate information of the exact coordinates in the first direction can be obtained by scanning in the second direction over the oblique markings. By uniquely varying the thickness of each marking such that each two, three, four or five consecutive markings form a unique combination of thicknesses, coordinate information may accurately be encoded. This manner of encoding may in the design of the fiducial marker for example be alternated by through lines extending in the first direction in a side by side arrangement in the second direction, having the oblique markings in between. By varying the thickness of the through lines dependent on their location in the second direction, the coordinates of the second direction can be encoded therein. In this way, scanning of the fiducial in a single direction (e.g. the second direction) provides both the coordinates in the first and the second direction. Here, also the inter-distance between the oblique markings or through lines may in a similar manner be varied to provide a compact design. The term ‘regular’ in ‘regular arrangement of markings’ in this respect thus refers to the regular occurrence of markings or lines extending all in a same direction, and must not be interpreted limited in the sense of defining a regular inter-distance between these markings or through lines. Although the inter-distance may be chosen fixed if desired, variable inter-distances allow for encoding more information per surface area and thus provides an advantageous embodiment. An example of such a pattern may be found further down below and in the figures, to be discussed later.

In view of the above, in some embodiments the extension direction and the arrangement direction are under and angle with respect to each other, wherein the angle is larger than 0 radians and wherein the angle is smaller than or equal to π/2 radians, such as and angle of π/2 radians or an oblique angle. The angle may be π/2 radians or π/4 radians, but may have any desired value in the abovementioned range (e.g. π/6 radians, π/5 radians, π/3 radians, 5π/12 radians or 1,316 radians, whichever angle is desired). The angle selected will determine the information density in the arrangement direction, and thus to some extent the achievable resolution, for example.

In some embodiments, at least one of the extension direction and the arrangement direction is parallel to the first direction and the other one of extension direction and the arrangement direction is parallel to the second direction. Regular patterns of lines in horizontal and vertical direction are an example of this.

In some embodiments, for the first regular arrangement of markings the extension direction is parallel to the first direction and the arrangement direction is parallel to the second direction; and for the second regular arrangement of markings, the arrangement direction is parallel to the first direction and the extension direction is at an oblique angle with the first direction. This describes the abovementioned patterns that can be scanned in a single direction to provide the coordinates in two directions.

In accordance with some embodiments, the markings are designed as trenches or elevations of a reference surface onto which the fiducial marker is to be created, wherein each trench or elevation comprises one or more side walls stepping up or stepping down from the surface, wherein at least a part of the one or more side walls is shaped to lean forward such that an upper part of the or each side wall is overhanging with respect to a lower part of the or each side wall. Images obtained using an atomic force microscope are strongly dependent on the shape of the probe tip. To be able to properly reconstruct an AFM image, it is also desired to calibrate the system for the shape of the tip. In the abovementioned embodiments, by designing the side walls of trenches and elevations such as to lean forward to create an overhanging part or edge, the system can be calibrated for the shape of the probe tip. Due to the overhanging edge, upon sliding down from an edge the sensed elevation profile will be determined only by the shape of the probe tip. This profile follows the slanting edge of the tip, and thus will provide an accurate image of the shape of the probe tip.

In a further aspect, there is provided a fiducial marker comprising a fiducial marker design in accordance with the first aspect above. In some embodiments thereof, the at least one first reference pattern is configured for being sensed using an optical sensor, and the at least one second reference pattern is configured for being sensed using a probe tip of a scanning probe microscopy device by scanning of the probe tip across a surface containing the fiducial marker. These fiducial markers may advantageously be applied for calibrating the location of a probe tip in an SPM system as explained above.

In accordance with a third aspect, there is provided a scanning probe microscopy device comprising a metrology frame, at least one probe head and a substrate carrier, the substrate carrier configured for supporting therein a substrate having a substrate surface, the at least one probe head comprising a probe including a cantilever and a probe tip, wherein the scanning probe microscopy device is configured for bringing the probe tip in contact with the substrate surface, and for moving the probe head and the substrate carrier relative to each other using an actuator acting on at least one of the probe head or the substrate carrier, wherein at least one of the substrate carrier or the metrology frame comprises a reference surface, the reference surface being scannable by the probe tip, and the reference surface including a fiducial marker having a fiducial marker design according to the first aspect; wherein the probe head further comprises a first sensor configured for operating at a first scale of dimension and for sensing of the first reference pattern for determining a relative position of the fiducial marker with respect to the first sensor; and wherein a second sensor configured for operating at a second scale of dimension smaller than the first scale of dimension, is formed by the probe tip.

For example, in some embodiments, the device comprises a plurality of probe heads, each probe head including at least the first sensor and the second sensor formed by the probe tip of the respective probe head, wherein the scanning probe microscopy device is configured for placing each probe head relative to the substrate surface, and wherein the scanning probe microscopy device comprises a positioning reference plate including a coordinate reference for positioning each probe head relative to the substrate in a desired position. In such a system, probe replacements and tip exchanges are even more frequent, and the advantages of the claimed invention will be even more explicit.

In some embodiments, the first sensor is an optical sensor, such as a microscopic sensor configured for operating at a sub-micrometer scale such as to visualize features having a dimension larger than 0.25 micrometer.

In accordance with a fourth aspect, there is provided a method of calibrating a position of a probe tip in a scanning probe microscopy device, wherein the scanning probe microscopy device comprises a metrology frame, at least one probe head and a substrate carrier, the substrate carrier configured for supporting therein a substrate having a substrate surface, the at least one probe head comprising a probe including a cantilever and the probe tip, wherein at least one of the metrology frame or the substrate carrier comprises a reference surface including thereon a fiducial marker comprising a fiducial marker design in accordance with the first aspect; wherein the probe head further includes a first sensor configured for operating at a first scale of dimension, and wherein the second sensor if formed by the probe tip, the second sensor thereby being configured for operating at a second scale of dimension smaller than the first scale of dimension; wherein the method comprises the steps of: obtaining a sensor signal from the first sensor, the sensor signal enabling visualization of at least a part of the fiducial marker including at least a part of a first reference pattern; determining, using a controller, a relative position of the fiducial marker with respect to the first sensor by analyzing, based on the sensor signal, the first reference pattern; and scanning, using the probe head, a second reference pattern with the probe tip in at least one scanning direction such as to determine therefrom a relative position of the probe tip with respect to the second reference pattern.

### BRIEF DESCRIPTION OF THE DRAWINGS

The invention will further be elucidated by description of some specific embodiments thereof, making reference to the attached drawings. The detailed description provides examples of possible implementations of the invention, but is not to be regarded as describing the only embodiments falling under the scope. The scope of the invention is defined in the claims, and the description is to be regarded as illustrative without being restrictive on the invention. In the drawings:

FIGS. 1A through 1C schematically illustrate a calibration method where a fiducial marker design in accordance with an embodiment of the present invention can be applied;

FIG. 2 schematically illustrates a fiducial marker design in accordance with an embodiment of the present invention;

FIGS. 3A and 3B illustrate some details of a fiducial marker design in accordance with the embodiment illustrated in FIG. 2;

FIG. 4 schematically illustrates a fiducial marker design in accordance with a further embodiment of the present invention;

FIGS. 5A, 5B and 5C schematically illustrate some specifics of the fiducial marker design illustrated in FIG. 4; and

FIG. 6 schematically illustrates a cross section of a part of a fiducial marker design in accordance with an embodiment of the present invention.

### DETAILED DESCRIPTION

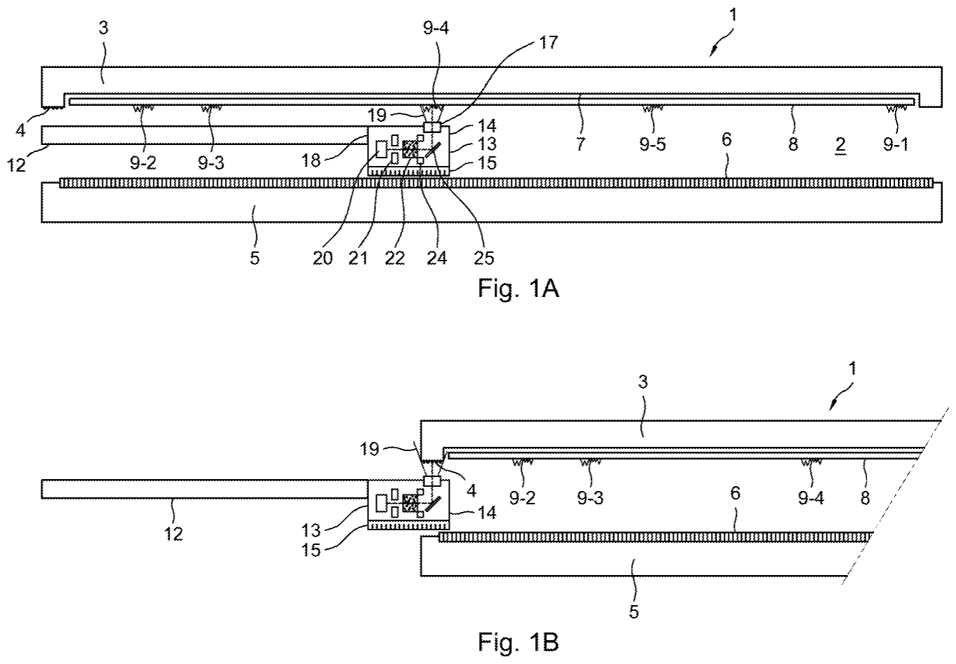

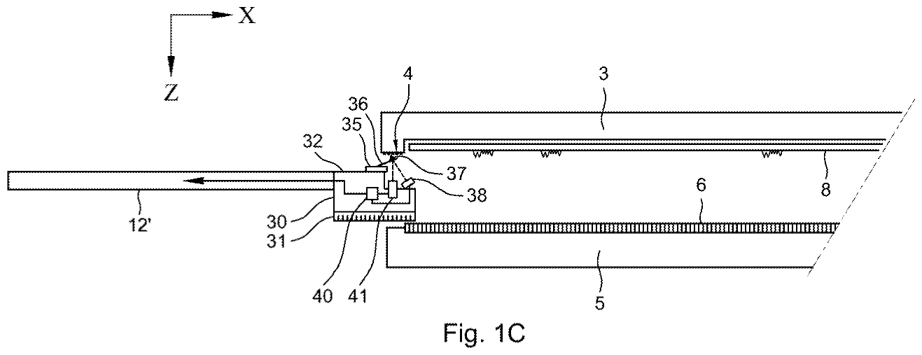

FIGS. 1a through 1c, illustrate a calibration method for calibrating a scanning probe microscopy system 1. This calibration method amongst others includes a probe tip calibration method in accordance with the present invention, although FIGS. 1a to 1c also elucidate the calibration of some other components of the system to provide some exemplary context. This must not be interpreted limiting on the invention, which primarily focusses on a fiducial marker design and a fiducial marker than may advantageously be used for calibration of the probe tip. Such a method is to be performed after each probe tip replacement, and may thus well be applied in absence of other calibration steps of the system that are to be carried out less frequently or maybe even once only. Furthermore, the calibration of other components can be carried out in many different ways, and also the SPM system 1 may have a different design including different components, giving rise to a different manner of calibrating. For example, the first sensor does not need to be the optical sensor described below, but may be a different type of sensor operating differently.

In FIG. 1a, a scanning probe microscopy system 1 comprises a base 5 and a substrate carrier 3. The base 5 may be fixed to a metrology frame or may be part of a metrology frame, and comprises a coordinate reference grid plate 6. The coordinate reference grid plate 6 is part of a grid encoder, which consists of the plate 6 and at least one encoder 15. In the system 1 in accordance with the present invention, a plurality of encoders may cooperate with the grid plate 6. For example, each element that is moving within the working space 2 between the sample carrier 3 and the grid plate 6 may comprise an encoder 15 that cooperates with the grid plate 6 in order to determine its position on the grid plate 6. The encoder 15, and each other encoder cooperating with the coordinate reference grid plate 6, (reads) the reference grid in order to obtain the coordinate data of its current location on the grid 6. Notably, the application of a coordinate reference grid plate 6 is itself optional, although it is advantageous to apply in order to achieve high throughput in an industrial setting, for example. Alternatively, it is also possible to exactly determine the location of any component by using one or more interferometers, or by relating their output to a detailed ‘blue-print’ of a substrate to be sensed. The invention is not limited to the application of a coordinate reference grid plate 6, and different ways of coordinate referencing across the substrate carrier 3 may be considered.

In FIG. 1a, the encoder 15 is mounted on a support 13 which is part of an arm 12 of a positioning unit module. The support 13 comprises an optical sensor 14 and the encoder 15. The optical sensor 14, in the illustrated embodiment, includes a miniature camera unit 20 having a field of view 19 through its sensor opening 17. The optical sensor 14 further comprises an aperture 21, a focusing lens 22 and actuators 24. The actuators 24 enable to adjust the distance between the camera 20 and the focusing optics 22 for enabling focusing of the image on the surface of the substrate 8. Furthermore, in order to make use of the available space parallel to the surface of the grid plate 6 in the working space 2, a mirror 25 redirects the field of view of the camera 20 from a horizontal into a vertical direction as illustrated in FIG. 1a. The optical sensor 14 is mechanically fixed to the support 13 and the arm 12, as will be described later. Furthermore, electrical connections for data transfer to the system 1 are provided via the electrical connection interface 18.

Preferably, the camera 20 is accurate enough to be able to recognize alignment marks on a wafer 8. The sizes of such marks may be within a range of 20*20 micrometer up to 50*50 micrometer, but of course the size of these marks may vary and may become smaller over time. The resolution of the image features of alignment marks may typically be down to 1 micrometer, which may likewise be subject to change (i.e. decrease) over time. The camera 20 may be adapted accordingly dependent on the size and/or resolution of the alignment marks, and should be able to distinguish the necessary image features in order to carry out its task. For example, pixel resolution of camera 20 in the object plane (e.g. surface to be read, bearing the marks) may be smaller than or equal to 2 micrometer, preferably smaller than or equal to 1.0 micrometer, more preferable smaller than or equal to 0.5 micrometer. Furthermore, magnification of the camera may be 5 to 100 times, preferably 10 to 50 times, and the camera may be able to operate with at least two magnification factors for low and high magnification. The camera must be able to detect alignment features on a wafer surface, which may be placed as close as 1 millimeter from the edge of the wafer. Power consumption of the camera is preferably as low as possible to reduce thermal dissipation and unwanted effects on the accuracy. The field of view 19 of camera 20 may be at least 0.5 millimeter, preferably at least 0.9 millimeter.

FIG. 1a schematically illustrates a method to calibrate various components of the system to the coordinate reference grid plate 6 in order to enable any element in the working space 2 to be properly navigated in use. The method of the present invention for calibrating the probe tip may be used in combination with the method of FIG. 1a and may be a part thereof. As mentioned before, probe tip calibration may also be carried out in absence of a method as illustrated in FIG. 1a, e.g. after each probe tip exchange.

In FIG. 1a, a calibration wafer 8, which is provided by a special wafer with alignment marks 9 (i.e. 9-1 . . . 9-5 . . . 9-n) is provided on the sample carrier 3, thereby providing a substrate surface that can be used for calibration of the system 1. Furthermore, the sample carrier 3 comprises, e.g. on an edge thereof, a fiducial marker 4 in accordance with the present invention, or having a design in accordance with the invention, which will be discussed later. The method of FIG. 1a allows to associate the optical sensor 14 with a location on the coordinate reference grid plate 6 in the SPM system 1. If any of these elements: the optical sensor 14 or the grid plate 6, is to be replaced, a new calibration of the system 1 is needed in order to obtain a correct geometric relation between these elements. However, because typically neither the grid plate 6, nor the optical sensor 14 requires frequent replacement, the calibration step may typically be performed on first use of the system 1, and occasionally only after replacement of any of these elements. As may be appreciated, a skilled person is free to perform the calibration step as often as deemed necessary or desired though.

The first step illustrated in FIG. 1a is the sensing, or imaging, of a sufficient number of calibration markers 9-n by the optical sensor 14. This is done by moving the optical sensor 14 across the surface of the grid 6 while obtaining location data of the current location of encoder 15 of the support 13. For example at each of the locations 9-1, 9-2, 9-3, 9-4 and 9-5 illustrated in FIG. 1a, the optical sensor 14 obtained an image of the calibration marker, e.g. calibration marker 9-4, while registering, associated therewith, the current location data obtained from the encoder 15. The layout of the calibration wafer 8 is exactly known in the system 1, and therefore by taking the images from the calibration markers 9-n and registering these associated with the location data obtained from the encoder 15, a relation between the positions of the calibration markers 9-n and the location data from the coordinate reference grid 6 can be established. This provides the geometric relation between the optical sensor 14 and the grid plate 6. As may be appreciated, it is important herein that the optical sensor 14 is fixed relative to the encoder 15 such that the location data obtained from the encoder 15 can be reliably related to the images obtained with the optical sensor 14.

Although in FIG. 1a, the step of obtaining a relation between the relative positioning of the optical sensor 14 and a coordinate reference grid 6 is performed using a calibration wafer 8, the skilled person may appreciate that it is not an essential step to the invention to use a calibration wafer such as wafer 8. Alternatively, known fixed references in the system 1 may likewise be used for determining such a relation. For example, in an alternative embodiment the substrate carrier 3 may for example include scannable calibration references directly on its bearer surface 7, such that the loading of a calibration wafer 8 is not required. Also the calibration wafer 8 not necessarily needs to be a special wafer comprising special marks, but may also be a wafer of which the layout is exactly known in the system 1, and which comprises distinguishable marks on its surface. The skilled person may recognize the various alternatives for implementing this step.

Another calibration method to be performed within the system 1 is the determination of a relative offset location of the probe tip 37. FIGS. 1b and 1c illustrate the method in accordance with an embodiment of the present invention. However, the steps illustrated in FIGS. 1b and 1c are merely examples in accordance with one embodiment of the invention, and in an alternative embodiment this relative offset location of the probe tip 37 may be determined in a different manner. The offset may be determined with respect to any other fixed part of the scan head 30, such as the optical encoder 31. Where the scan head includes the optical sensor 14, the head encoders 15 and 31 may be one and the same encoder. In these cases the offset of the probe tip 37 may be related to either one or all of the optical sensor 14 or the head encoder 31/15.

Briefly referring to FIG. 1c, the relative offset location of the probe tip 37 with respect to the head encoder 31 defines a relation between the location data obtained with the head encoder 31 and the exact location of the probe tip 37 at that moment. This information is needed in order to be able to properly navigate the probe tip 37 to a desired location for scanning a substrate surface, as will be explained later. A scan head 30 may comprise a variety of different elements, but at least includes the encoder 31 and the miniature atomic force microscope unit 32, and in some implementations the optical sensor 14. The miniature AFM unit 32 includes a probe 35 including a cantilever 36 and a probe tip 37. The probe tip 37 is used to scan across the surface of e.g. a substrate, in order to determine the geometry of the surface topography of the substrate or the exact locations of embedded structures underneath the surface of the substrate using e.g. an acoustic signal applied to the substrate or the probe 35 or both. In the example illustrated in FIG. 1c a regular topography measurement is illustrated schematically. The miniature AFM 32 thus comprises a probe 35, a laser 41 (e.g. a semiconductor laser) and an optical sensor 38. The laser 41 and the optical sensor 38 together form an optical beam deflection unit (OBD unit) which enables to exactly determine the deflection of the probe tip 37 due to surface structures sensed with the AFM. The laser 41 and the optical sensor 38 are controlled by controller 40 which also obtains the sensor signal from optical sensor 38 and e.g. location data from the encoder 31. This is transmitted to the system electronics 1. In the embodiment illustrated in FIG. 1c, the scan head 30 comprises an onboard processor 40 that is used as a controller of a scan head. The skilled person may appreciate that a decentral controller may be located somewhere in the SPM system 1 to perform the same and/or additional tasks as described herein.

In relation to the present invention, the optical sensor 14 will serve as the first sensor or coarse sensor, i.e. operating at a first scale of dimension, whereas the probe tip 37 will serve as the second sensor, i.e. operating at a second scale of dimension which is smaller than the first scale of dimension. Back to FIG. 1b, the step of determining a relative offset location for the probe tip 37 is performed by first performing a step of determining, using the optical sensor 14 described above, location data of a fiducial marker 4 in accordance with an embodiment of the invention, which is located on the substrate carrier 3. This is done by imaging the fiducial marker 4 with the optical sensor 14, while taking a current location of the support 13 by the encoder 15. To pinpoint the location of fiducial marker 4, the fiducial marker 4 comprises a first reference pattern that includes first reference elements which will be discussed in greater detail further below. Based on the first reference elements, using a blob detection algorithm, the exact position of the fiducial marker 4 in accordance with the invention may be determined. The step of scanning the fiducial marker 4 with the optical sensor 14 is needed each time when the system 1 is used because the location of the fiducial marker 4 in the SPM system 1 is not fixed. The reason for this is that temperature differences in and around the SPM system 1 result in miniature differences in the exact location of the fiducial marker 4. Therefore, at least each time when the system 1 is used, but more preferably as often as necessary, this calibration step may be performed.

Furthermore, e.g. thereafter, in accordance with the invention, the step illustrated in FIG. 1c can be performed. Here, the surface of the fiducial marker 4 is scanned with the probe tip 37. The fiducial marker 4 is not a regular type fiducial marker, but includes a fiducial marker design in accordance with the present invention. The fiducial marker 4 includes a second reference pattern, in addition to the abovementioned first reference pattern. The second reference pattern includes a regular arrangement of markings wherein coordinate information is encoded, storing therein the coordinates of the location within the fiducial marker 4. This will be explained in more detail below. By scanning this second reference pattern with the probe tip 37, it is possible to obtain these coordinates during scanning. Because the exact location of the fiducial marker 4 is known, after having determined this using the optical sensor 14, it is possible to directly derive the exact offset position of the probe tip 37 during said scanning. This obviates the need for analysis methods such as image recognition in order to relate the location of the probe tip 37 to a known position within the system. Once the exact location of the fiducial marker 4 is available to the system 1, even a single line scan (in some embodiments) of the probe tip 37 or two line scans (in other embodiments) enables to perform the probe tip calibration method of the present invention. From this, after the calibration has been performed, using the coordinate system already obtained during the calibration step illustrated in FIG. 1a, the scan head 30 including the encoder 31 and miniature AFM 32, can be navigated through the working space 2 to any location relative to the grid plate 6 in order to obtain images of the substrate.

FIGS. 1b and 1c illustrate the calibration wafer 8 in the sample carrier 3. This calibration wafer 8 is not needed during the steps illustrated in FIGS. 1b and 1c, and may be completely absent while performing these steps. The determination of the relative offset of the probe tip 37 in the example illustrated in FIGS. 1b and 1c is completely based on the location of the fiducial marker 4. In this embodiment, the fiducial marker 4 is located on the substrate carrier 3. The skilled person may appreciate that it may also be located elsewhere in the SPM system 1, for example on a scannable location on the metrology frame. Any reference surface reachable by the probe tip 37 may be used. Alternatively, the fiducial marker may be present on a wafer, such as wafer 8. This could be helpful if the system 1 itself does not include the fiducial marker 4, e.g. in legacy systems. In that case, the calibration method must also exactly determine the position of the fiducial marker 4 in relation to a fixed reference in the SPM system 1, such as the metrology frame or base 5 or the coordinate reference grid plate 6. This may again be done using the optical sensor 14 as first sensor, e.g. relating it to the grid plate 6 via the encoder 31 or 15.

The data obtained with the steps illustrated in FIGS. 1a, 1b and 1c forms the basis for enabling navigation through the working space 2. As indicated hereinabove, the step of determining relative offset position of the probe tip 37 with respect to the encoder 31 may be performed in a different manner than is illustrated in FIGS. 1b and 1c. For example, in accordance with an embodiment of the present invention, the optical sensor 14 may be jointly mounted to a support arm 12 including an atomic force microscope 32. The both systems may be integrated in such a way that the field of view 19 of the optical sensor 14 includes at least the probe tip 37. In this way, each image that is taken with the optical sensor 14 includes the location of the probe tip 37. If the fiducial marker 4 is located on a fixed (stationary) part of the system 1 where its location is known, this enables to directly associate the probe tip location 37 to the location of the optical sensor 14 as well, and verification is also possible via the encoder 31 to provide a further check.

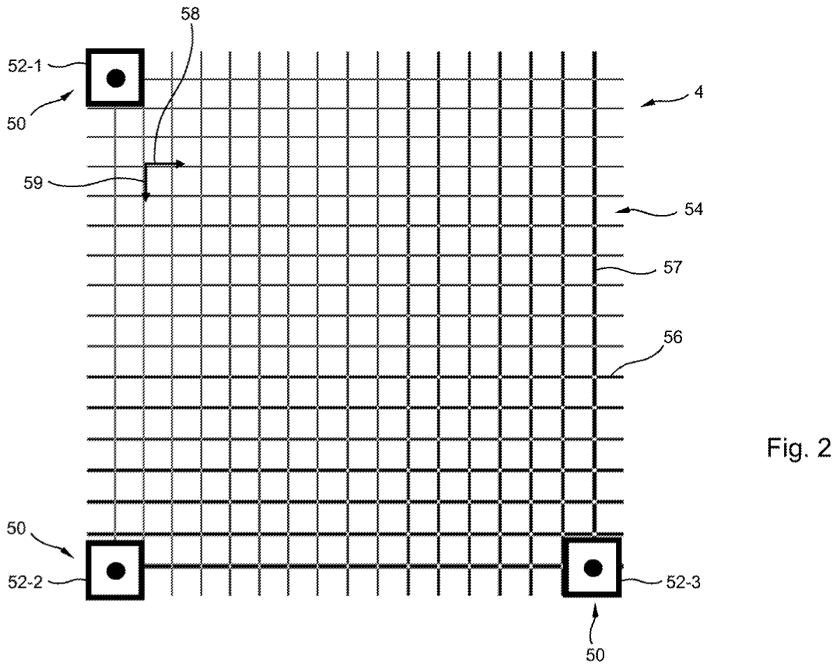

FIG. 2 schematically illustrates a fiducial marker 4 created using a fiducial marker design in accordance with the present invention. The fiducial marker 4 comprises a plurality of horizontal lines or bars 56 and vertical lines or bars 57 forming the markings 56, 57 of the second reference pattern 54. Furthermore, the fiducial marker design of fiducial marker 4 comprises a first reference pattern 50 comprising reference elements 52-1, 52-2 and 52-3. In the design illustrated in FIG. 2, the number of horizontal or vertical markings 56 and 57 may be chosen dependent on the needs of the specific case, and the design is not limited to the number of markings illustrated in the figure. Also, additional markings that are not necessarily running in the vertical or horizontal direction may be present in a design in accordance with the present invention, without departing from the scope of the appended claims. Also, the reference elements 52-1 through 52-3 of the fiducial marker 4 of FIG. 2 may be of any desired size or shape, and also the number of these reference elements 52 does not need to be exactly three. In this respect, the skilled person may appreciate that the application of at least three reference elements 52 allows the application of a blob detection algorithm, known to the skilled person, for enabling to calibrate the X, and Y directions as well as the rotation R_{z} in a Cartesian coordinate system. This blob detection algorithm may thus be used to calibrate the location and orientation of the fiducial marker for enabling the fiducial marker to be used as a positioning reference in a system. The size of reference elements 52-1 through 52-3 is large enough such as to enable to detect the reference elements 52 using the optical sensor 14 and enable the blob detection algorithm to perform the above calibration. With this information available, the markings 56 and 57 of the fiducial marker 4 may be scanned using the probe tip 37 in order to determine the relative offset location of the probe tip 37. The preferred scanning directions are for example illustrated as directions 58 and 59 in FIG. 2, although it is important to realize that it is not important that the directions 58 and 59 are aligned with the directions of the markings 56 and 57 as illustrated in FIG. 2.

By scanning the markings 56 and 57 using the probe tip 37, each time a marking is encountered by the probe tip 37, the elevation of the surface onto which the fiducial marker 4 is printed will change. For example, if the markings 56 and 57 are formed by trenches in the surface, this is encountered by the probe tip 37 by falling into these trenches. If the markings, however, are provided by elevated structures, these elevated structures are encountered by the probe tip as a rise of the surface elevation. Such changes in deflection of the probe tip caused by the changes in the local elevation, are detected by monitoring the output signal obtained from the optical beam deflector (OBD) arrangement on the scan head (or alternative sensor to detect deflection changes). From the output signal, the dimensions and/or properties of the encountered structures, such as the thickness of a line, the depth of a trench, or the roughness of a surface, can be determined.

In accordance with the present invention, each of the markings 56 and 57 individually can be uniquely identified upon scanning thereof by the probe tip 37. For example, in the embodiment illustrated in FIG. 2, from left to right the thickness of the markings 57 increases, and each of the markings 57 has a unique thickness. Therefore, by detecting the thickness of a marking 57 upon scanning thereof with the probe tip 37, the SPM system 1 is able to uniquely determine which marking 57 is presently encountered by the probe tip 37. Similarly, from top to bottom the thickness of the markings 56 likewise increases for each of the individual markings 56. Therefore, by crossing each of the markings 56, the sensor signal obtained using the optical beam deflector of the SPM system that follows the surface elevations encountered by the probe tip 37 enables to exactly determine which of the markings 56 is encountered by the probe tip. Therefore, together the markings 56 and 57 of the fiducial marker 4 form a coordinate system wherein the location of the probe tip 37 is exactly known when it encounters each of the individual markings 56 and 57. The structuring of the markings 56 and 57 is regular, and the interdistance between each two adjacent markings 57 and each two adjacent markings 56 is exactly known by the system. As a result, from the signals obtained from the scan head 30 during scanning, the exact location of the probe tip 37 can be calculated from the signal at any time and any position on the surface of the fiducial marker 4.

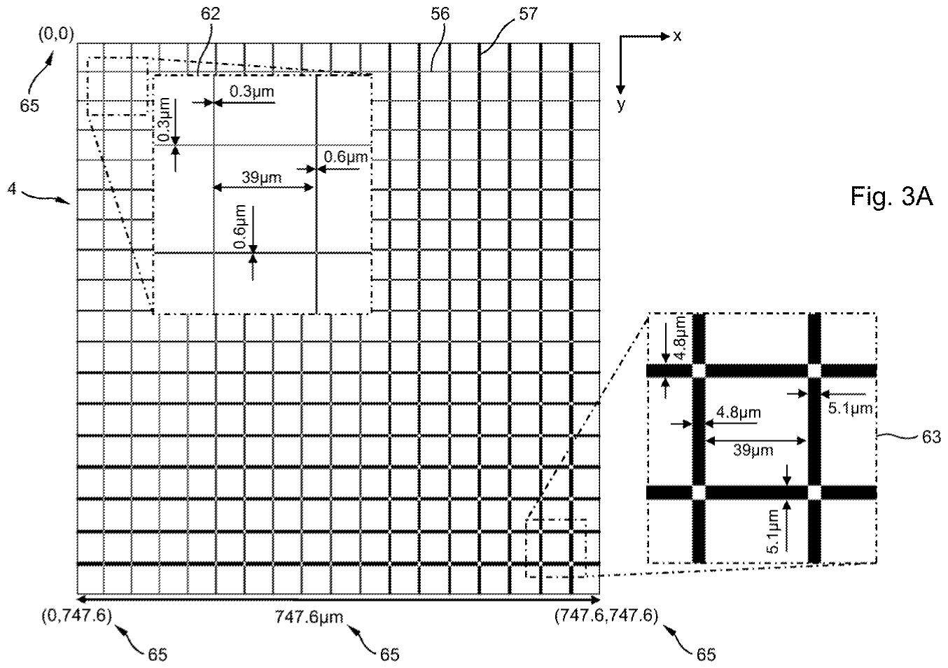

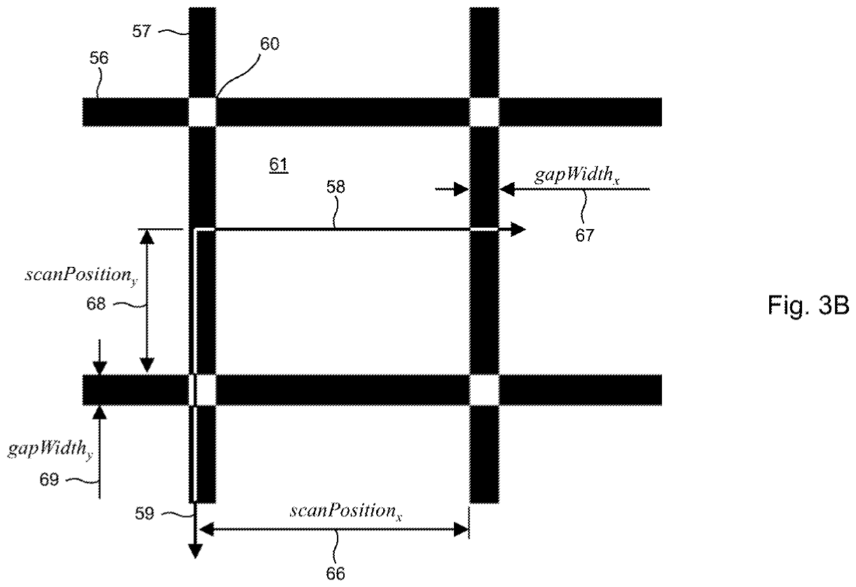

The markings 56 and 57 of fiducial marker 4 form a coordinate system in two orthogonal directions X and Y. FIG. 3A again illustrates these markings 56 and 57 and provides information on the exactly chosen interdistance between the markings and the thickness of the markings 56 and 57. To this end, reference is made to the enlarged portions 62 and 63 in FIG. 3A. Furthermore, at each of the corners 65 of the fiducial marker the exact relative position within the coordinate system can be calculated. The origin of the coordinate system is formed by the upper left corner 65 in FIG. 3A and in the embodiment illustrated, the size of the fiducial marker is the square of size 747.6 micrometer in width and length. FIG. 3B schematically illustrates how the exactly known sizes of each of the markings 56 and 57 and their known interdistance allows to determine the parameters with which the exact location of the probe tip 37 within the fiducial marker 4 can be calculated.

Back to FIG. 3A, from the enlarged portions 62 and 63, it is clear that the interdistance between each two lines 56 and each two lines 57 is exactly 39 μm. In the upper left corner of the fiducial marker 4, as follows from the enlarged portion 62, the first vertical line 57 has a thickness of 0.3 μm. The thickness of each subsequent vertical line 57 increases with 0.3 μm. Therefore, the next vertical line 57 visible in the enlarged portion 62 has a thickness of 0.6 μm. Similarly, for the first horizontal line 56 at the top of the enlarged portion 62, the thickness is likewise 0.3 μm. Again, for each subsequent horizontal line 56 below, the thickness increases with 0.3 μm at the next horizontal line 56 has a thickness of 0.6 μm. In the example of FIG. 3A, all the way at the lower right corner of the fiducial marker 4, in the enlargement portion 63, it can be seen that the most right vertical line 57 has a thickness of 5.1 μm, which is the same for the bottom horizontal line 56 in the enlargement portion 63. The interdistance between each two horizontal lines 56 and each two vertical lines 57 remains to be 39 μm. On each crossing between horizontal lines 56 and vertical lines 57, for example crossing 60 in FIG. 3B, the color is inverted such as to enable detection of the crossings when the probe tip 37 incidentally would follow the horizontal line 56 or the vertical line 57 of the fiducial 4 across its length (instead of crossing it). This feature is however not essential (the concept would work also without it, eventually requiring a third line scan in the eventuality that the probe lands in a trench as in 68: U-shaped scan instead of L-shaped).

In FIG. 3B, the thickness of the vertical lines 57 is denoted as gapWidthₓ 67. Likewise, the thickness of each horizontal line 56 is denoted as gapWidth_{y} 69. Furthermore, following the scan direction 58 in the horizontal direction, within each section 61 between two vertical lines 57, the vector 66 indicates the scanPositionₓ which is the current position of the probe tip 37 within section 61 of the fiducial marker 4, i.e. the length from the landing position until the beginning of gapWidthₓ. Furthermore, in the direction 59, the scanPosition_{y} indicates the present vertical position of the probe tip 37 in section 61 in a similar manner. To obtain the coordinates of the probe tip within the fiducial marker, using these parameters, the formula below may be applied.

$${[ \begin{matrix}x \\ y\end{matrix} ]}_{TIP \_ \# \_ CS} = [ \begin{matrix}39 \cdot n + ( 39 - {scanPosition}_{x} ) + {\sum }_{k = 1}^{n} {d}_{x} \cdot k \\ 39 \cdot m + ( 39 - {scanPosition}_{y} ) + {\sum }_{k = 1}^{m} {d}_{y} \cdot k\end{matrix} ] \qquad ( 1 )$$

Herein x and y are the current tip position of the probe tip 37, and n is the count number of the present section 61 counting from the edge of the fiducial marker 4 until the present section 61. The count number n can be calculated based on the gapWidthₓ, using the formula:

$$n = round ( \frac{{gapWidth}_{x} - {d}_{x}}{{d}_{x}} ) \qquad ( 2 )$$

Furthermore, dx is the incremental thickness step of the vertical lines 57 in the x-direction. Thus, the first line 57 has a thickness of 0.3 μm, and the thickness of each subsequent vertical line 57 is incremented with 0.3 μm for each following line. Furthermore, n is the section counter in the y-direction from the edge of the fiducial marker until the present section. The parameter d_{y} likewise is the incremental thickness step in the y-direction for each subsequent horizontal line 56. To calculate the section counter n in the y-direction, similar to calculation of n above, the following formula may be applied:

$$m = round ( \frac{{gapWidth}_{y} - {d}_{y}}{{d}_{y}} ) \qquad ( 3 )$$

In FIGS. 3A and 3B, the values dx and d_{y} are both 0.3 μm. For the lower most horizontal line 56, the gapWidth_{y} equals 5.1 μm as can be seen in a large portion 63. Using the value of 0.3 μm, it can be calculated that after crossing the lower most horizontal line 56, n equals n=18.

As follows from FIGS. 3A and 3B and the explanation above, the fiducial marker 4 in accordance with the present design enables to very accurately determine the exact position of the probe tip 37 within the fiducial marker. The coordinates of the probe tip 37 within the coordinate system encoded in the fiducial marker design may be determined from the markings 56 and 57 encountered. Because the exact location of the fiducial marker itself can also be determined using the reference elements 52-1, 52-2 and 52-3 and for example a blob detection algorithm, together with this fiducial marker design of fiducial marker 4, the exact location of the probe tip can be determined, which information can be used for all kinds of calibration methods.

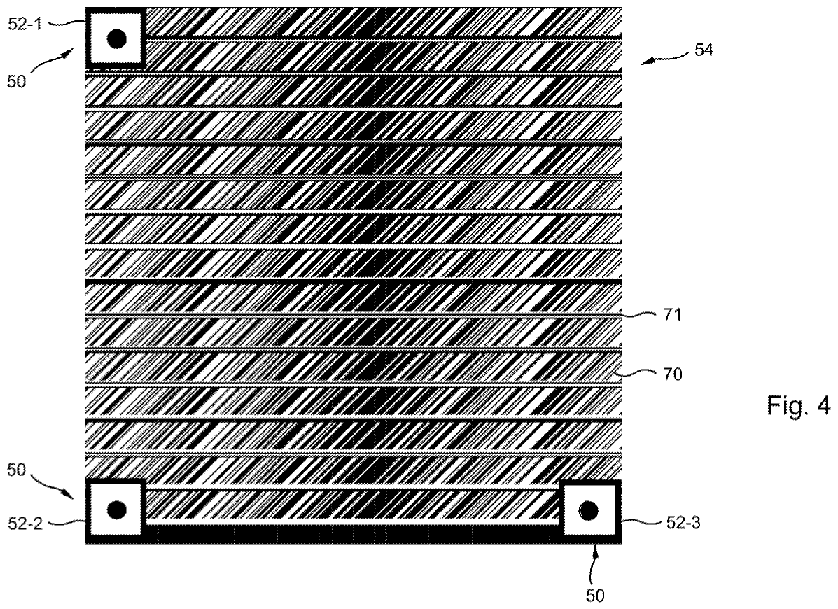

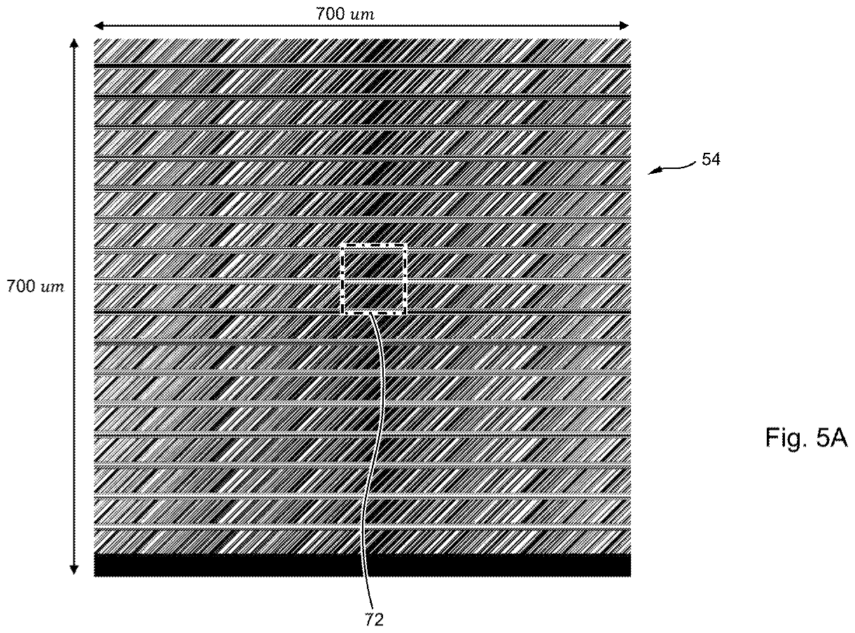

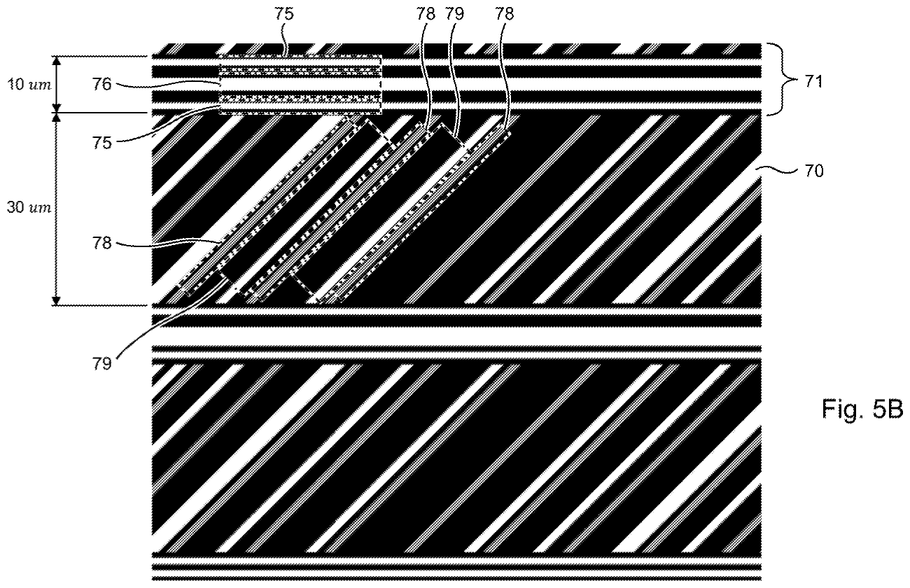

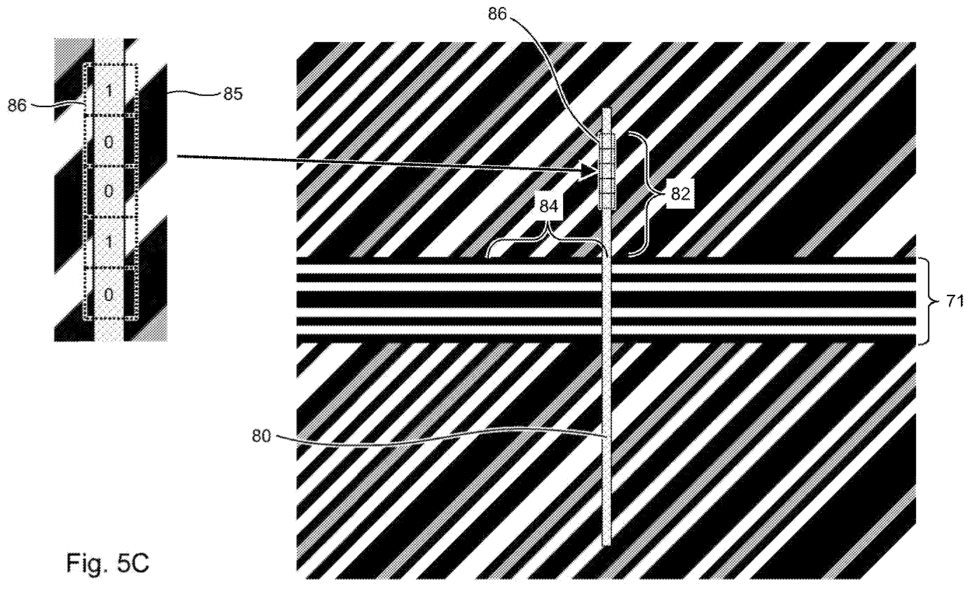

A further fiducial marker design is shown in FIG. 4. FIG. 4 illustrates a same first reference pattern 50 including same first reference elements 52-1, 52-2 and 52-3. Furthermore, the fiducial marker design illustrated in FIG. 4 includes an arrangement of markings 70, 71 in a second reference pattern 54 that enables to obtain coordinate data in the x and y direction by a single scan of the probe tip 37. The second reference pattern 54 is illustrated in FIG. 5A and an enlargement 72 thereof is illustrated in FIG. 5B. The size of the fiducial marker 4 illustrated in FIGS. 4 and 5A/B is in total 700 μm by 700 μm. The second reference pattern 54 consists of a plurality of markings 70 and 71, wherein the markings 71 in FIG. 4 consists of horizontal lines and the markings 70 consists of diagonal lines. The spacing between each two subsequent horizontal markings 71 is equal, such that a regular pattern of markings 71 is provided in a fiducial marker 4 of FIG. 4. The horizontal lines 71 encode the coordinates in the y-direction. Each of the markings 71 consists of a specific pattern of horizontal lines wherein information about the y-position is encoded by providing a unique pattern of lines. Each line has a specific texture, elevation or other determinable property, selected from a limited set of available textures, elevations or properties that are clearly distinguishable from the output signal of the SPM system. For example, the lines may be formed at two different elevations, such that a first elevation provides a first Boolean value (e.g. “0”) and a second elevation provides a second Boolean value (e.g. “1”). As may be appreciated, the invention is not limited to two contrasting properties. The contrasting ‘colours’ may be provided using three, four, five, six, . . . , ten, twenty (etcetera) distinguishable properties (i.e. multicolour). The lines of the markings 70, 71, 56 or 57 in that case may encode therein more information, in addition to coordinates. For example, lines of a specific function may be at a third distinguishable elevation level.

The diagonal lines 70 encode the x-position data. If a single scan is performed in the vertical direction across the fiducial marker 4, at an arbitrary but fixed x-position, then the crossings over each of the horizontal markings 71 provides the information of the current y-position of the probe tip, whereas a crossing of the probe tip over the diagonal lines provides a signal from which the present x-position can be determined. Therefore, a single scan in the vertical direction across the fiducial marker 4 of FIG. 4 exactly provides the x and y-position data at any point in the fiducial marker.

Turning to FIGS. 5A and 5B, in particular 5B provides an explanation of the various markings 70 and 71 and their function in the fiducial marker. The markings 71 providing the y-position data, consists of two terminal parts 75 and a data part 76. The terminal parts 75 are identical for each of the markings 71, and consists of for example two black lines and a white line. As explained, ‘black’ and ‘white’ herein may refer to different elevation levels, textures or other properties that are clearly distinguishable. Or two elevated regions and a depreciated region, or the like. The data part 76 consists of a pattern of four contiguous parallel lines which may be of a first or second value (elevated, depreciated, black, white, etc.). The colouring encodes therein the y-position data. For example, a sequence of black, white, white, black may encode the binary numbers 1, 0, 0, 1.

The diagonal lines 70 comprise terminal parts 78 and data parts 79. The terminal parts again consist of a recognizable pattern of lines which, upon crossing, indicate that a terminal part is crossed. The data lines consist of a sequence of five (or more or less) contiguous parallel lines encoding therein bit information indicative of the exposition. Furthermore, because the lines 70 including the markings 78 and 79 are diagonal, by knowing the exact y-position (measuring from the terminals of the markings 71 for the y-position, the y-position data at which a recognizable bit pattern is encountered in the data part 79 of the markings 70, is indicative of the accurate exposition within the fiducial marker. FIG. 5C illustrates for example the encoding of bit data in the sequence of lines in the data part 79. Here, the line 80 is a scan trajectory of a probe tip 37 crossing the fiducial marker 4. At the positions indicated by 86, the probe tip subsequently encounters (from top to bottom) the binary numbers 1, 0, 0, 1, 0, which is indicative of the binary number 10010 which equals 18. This can be used to calculate the exact x-position using the formula below:

$${[ \begin{matrix}x \\ y\end{matrix} ]}_{TIP \# CS} = [ \text{} \begin{matrix}0. + {i}_{x , code} \cdot ( 3 \cdot {d}_{endbit , x} + {N}_{databit , x} \cdot {d}_{databit , x} ) + {scanPosition}_{x} \\ 310.0 - {i}_{y , code} \cdot {d}_{ydata} - ( {i}_{y , code} + 1 ) \cdot {d}_{y , spacing} + {scanPositie}_{y}\end{matrix} ] \text{} \qquad ( 4 )$$

Herein, the parameter i_{x,code} is the encoded x data for example the data from the sequence 86 in FIG. 5C. A parameter d_{endbit,x} is the thickness, in the scan direction, of the individual lines that together make up the terminals 78 for the x-position data. Since there are three lines, this thickness is multiplied by three. The parameter N_{databit,x} equals the number of bits encoded in the x-position data 79. In the example of FIG. 5C, N_{databit,x} equals 5. The parameter d_{databit,x} is the thickness of each of the individual lines making up the data lines 79, in the scan direction. The scan position x is the distance 84 from the position where the terminal 78 meets the terminal 75 of the markings 71, until the location of the scan trajectory 80. The parameter scan position, equals the distance 82 starting from the end of the terminal 75 to the present scan position of the probe tip 37 on the scan line 80. The parameters i_{y,code} is the encoded data from the data part of the markings 71, and the parameter d_{ydata} is the thickness of the markings 71 in full (including the terminals 75). The parameter d_{y,spacing} is the interdistance between the markings 71 (here 30 μm). The thickness of the markings 71 in the example of FIGS. 5A through 5C equals 10 μm.

Although the fiducial marker 4 of the design of FIGS. 4 and 5A through 5C is clearly advantageous in terms of providing x and y data from a single scan over the fiducial marker, a disadvantage of this fiducial marker is that it is less tolerant with respect to an incorrect orientation of the scan path with respect to the y-position markings 71. The scan direction must be transverse to the direction of the y-position markings 71 in order to provide most accurate x and y data. In the embodiment illustrated in FIGS. 2, 3A and 3B, the tolerance with respect to misalignment of the scan path is much better, although in this fiducial two scans must be made in order to obtain all data required for determining x and y-position of the probe tip 37 in the fiducial marker 4.

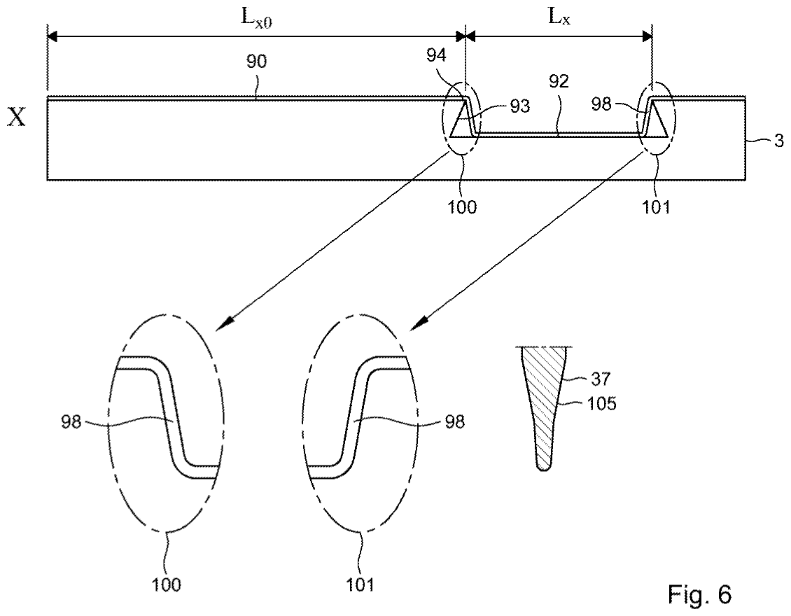

FIG. 6 illustrates a further aspect of some embodiments of the present invention. In this figure, a cross section of a fiducial marker 4 including a trench 92 is illustrated. The walls 93 of the trench 92 provide an overhanging edge 94 with respect to the elevated parts 90. By providing an overhanging edge 94, it can be guaranteed that the height measurements from the probe tip scan upon encountering an edge 94 provide the correct profile of the probe tip 37. This is illustrated in FIG. 6. In the enlarged portions 100 and 101, the probe tip signal 98 is illustrated that is obtained upon encountering each of the edges 94. In the scan direction, these provide the left and right parts of the tip shape of the probe tip 37. By assembling these signals in the way illustrated in FIG. 6 to the right of the enlargement part, the exact profile 105 of the probe tip 37 may be obtained. As may be appreciated, this can be done in any direction wherein an edge is provided. For example, in the embodiment of FIGS. 2 and 3 this can be done in the x and y direction.

The fiducial marker design may be applied to a scanning probe microscopy system, for example to the metrology frame thereof or to a substrate carrier, hence fixed to the system itself. It thereby enables to provide a positioning reference that may be seen or sensed using a coarse sensor (e.g. a marks sensor, optical microscopic sensor element, charged coupled device or other camera). Alternatively or additionally, it may be applied to a substrate surface, e.g. a wafer to be examined using the SPM system, for the same purpose: i.e. to provide a positioning reference that may be seen or sensed using a coarse sensor as mentioned above. In both cases, the second reference pattern provides a fine positioning reference to the probe tip of the SPM, which enables from the encoded surface coordinate information to obtain an accurate surface coordinate from which the exact location of the probe tip can be obtained.

The present invention has been described in terms of some specific embodiments thereof. It will be appreciated that the embodiments shown in the drawings and described herein are intended for illustrated purposes only and are not by any manner or means intended to be restrictive on the invention. The context of the invention discussed here is merely restricted by the scope of the appended claims.

1. A fiducial marker design for use as a fiducial marker for providing a positioning reference, the fiducial marker comprising at least one first reference pattern including at least one first reference element for enabling determination of a relative position of the fiducial marker with respect to a first sensor, the first sensor being configured for operating at a first scale of dimension,
wherein the fiducial marker further comprises a second reference pattern, wherein the second reference pattern comprises a regular arrangement of markings, the markings having variable dimensions such as to encode therein surface coordinate information, for enabling determination of a relative position of each marking with respect to a second sensor, the second sensor being configured for operating at a second scale of dimension, the second scale of dimension being smaller than the first scale of dimension.

2. The fiducial marker design according to claim 1, wherein the second reference pattern includes a first regular arrangement of markings and a second regular arrangement of markings,
wherein the first regular arrangement of markings is structured or shaped such as to encode therein surface coordinate information of a first surface coordinate associated with a first direction parallel to the surface of the fiducial marker, and
wherein the second regular arrangement of markings is structured or shaped such as to encode therein surface coordinate information of a second surface coordinate associated with a second direction parallel to the surface of the fiducial marker.

3. The Fiducial marker design according to claim 2, wherein at least one of:
the first direction is transverse to the second direction for providing a cartesian coordinate system; or
the first direction is a radial direction extending outward from a center point, and the second direction is an angular direction extending circularly around the center point, such as to provide a polar coordinate system.

4. The fiducial marker design according to claim 2, wherein for at least one of the first or second regular arrangement of markings, each of the markings is provided by a bar having a predetermined thickness for encoding therein a sequence of binary values, wherein the bars extend in an extension direction and are arranged side by side in an arrangement direction.

5. The fiducial marker design according to claim 4, wherein the extension direction and the arrangement direction are under and angle with respect to each other, wherein the angle is larger than 0 radians and wherein the angle is smaller than or equal to π/2 radians.

6. The fiducial marker design according to claim 4, wherein at least one of the extension direction and the arrangement direction is parallel to the first direction and the other one of extension direction and the arrangement direction is parallel to the second direction.

7. The fiducial marker design according to claim 4, wherein for the first regular arrangement of markings the extension direction is parallel to the first direction and the arrangement direction is parallel to the second direction; and
wherein for the second regular arrangement of markings, the arrangement direction is parallel to the first direction and the extension direction is at an oblique angle with the first direction.

8. The fiducial marker design according to claim 1, wherein the markings are designed as trenches or elevations of a reference surface onto which the fiducial marker is to be created, wherein each trench or elevation comprises one or more side walls stepping up or stepping down from the surface, wherein at least a part of the one or more side walls is shaped to lean forward such that an upper part of the or each side wall is overhanging with respect to a lower part of the or each side wall.

9. The fiducial marker design according to claim 1, wherein at least one of:
the markings are provided having variable dimensions in one or two directions, wherein the coordinate information is encoded in the variation of these dimensions; or
the markings form regular pattern of rectangles, wherein the width gradually increases in one orthogonal direction and wherein the height gradually increases in a further orthogonal direction, such as to encode the coordinate information as cartesian coordinates;
the markings form a grid of horizontal and vertical lines, wherein the lines gradually increase in thickness for encoding the coordinate information.

10. A fiducial marker comprising the fiducial marker design in accordance with claim 1.

11. The fiducial marker according to claim 10, wherein the at least one first reference pattern is configured for being sensed using an optical sensor, and wherein the at least one second reference pattern is configured for being sensed using a probe tip of a scanning probe microscopy device by scanning of the probe tip across a surface containing the fiducial marker.

12. The fiducial marker according to claim 10, wherein the markings are provided by trenches or elevations of a reference surface onto which the fiducial marker is created, wherein each trench or elevation comprises one or more side walls stepping up or stepping down from the surface, wherein at least a part of the one or more side walls is shaped to lean forward such that an upper part of the or each side wall is overhanging with respect to a lower part of the or each side wall.

13. A scanning probe microscopy device comprising a metrology frame, at least one probe head and a substrate carrier, the substrate carrier configured for supporting therein a substrate having a substrate surface, the at least one probe head comprising a probe including a cantilever and a probe tip, wherein the scanning probe microscopy device is configured for bringing the probe tip in contact with the substrate surface, and for moving the probe head and the substrate carrier relative to each other using an actuator acting on at least one of the probe head or the substrate carrier,
wherein at least one of the substrate carrier or the metrology frame comprises a reference surface, the reference surface being scannable by the probe tip, and the reference surface including a fiducial marker having the fiducial marker design according to claim 1;
wherein the probe head further comprises a first sensor configured for operating at a first scale of dimension and for sensing of the first reference pattern for determining a relative position of the fiducial marker with respect to the first sensor; and
wherein a second sensor configured for operating at a second scale of dimension smaller than the first scale of dimension, is formed by the probe tip.

14. A scanning probe microscopy device according to claim 13, wherein the device comprises a plurality of probe heads, each probe head including at least the first sensor and the second sensor formed by the probe tip of the respective probe head, wherein the scanning probe microscopy device is configured for placing each probe head relative to the substrate surface, and wherein the scanning probe microscopy device comprises a positioning reference plate including a coordinate reference for positioning each probe head relative to the substrate in a desired position.

15. A method of calibrating a position of a probe tip in a scanning probe microscopy device, wherein the scanning probe microscopy device comprises a metrology frame, at least one probe head and a substrate carrier, the substrate carrier configured for supporting therein a substrate having a substrate surface, the at least one probe head comprising a probe including a cantilever and the probe tip, wherein at least one of the metrology frame or the substrate carrier comprises a reference surface including thereon a fiducial marker comprising the fiducial marker design in accordance with claim 1;
wherein the probe head further includes a first sensor configured for operating at a first scale of dimension, and wherein the second sensor if formed by the probe tip, the second sensor thereby being configured for operating at a second scale of dimension smaller than the first scale of dimension;
wherein the method comprises the steps of:
obtaining a sensor signal from the first sensor, the sensor signal enabling visualization of at least a part of the fiducial marker including at least a part of a first reference pattern;
determining, using a controller, a relative position of the fiducial marker with respect to the first sensor by analyzing, based on the sensor signal, the first reference pattern; and
scanning, using the probe head, a second reference pattern with the probe tip in at least one scanning direction such as to determine therefrom a relative position of the probe tip with respect to the second reference pattern.

16. The fiducial marker design according to claim 5, wherein the angle is π/2 radians or an oblique angle.
